(19) United States
(12) Patent Application Publication
(10) Pub. No.: US 2009/0082005 A1
(43) Pub. Date: Mar. 26, 2009

(54) METHODS AND DEVICES FOR COORDINATING A SINGLE TELEPHONE NUMBER

(75) Inventors: DEAN E. THORSON, GRAYSLAKE, IL (US); WILLIAM P. ALBERTH, JR., CRYSTAL LAKE, IL (US); SCOTT T. DROSTE, CRYSTAL LAKE, IL (US); HONG ZHAO, NAPERVILLE, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/860,012

(22) Filed: Sep. 24, 2007

(51) Int. Cl. H04Q 7/20

(52) U.S. Cl. 455/422.1

(57) ABSTRACT

The described methods and devices provide for transferal of an operational identity between two mobile communication devices of an activation pool, making one device active and another inactive, but maintain the same telephone number or other operational identity. The operational identity may be, for example, a user account number, a telephone number, or other identifier that can identify the active mobile communication device in the communication network so that telephone calls or other communications may be sent to and/or received by one device of the set of devices of the activation pool. A mobile communication device may transmit a signal to a server of the communication network to make active the mobile communication device and to operate the device under the operational identity. At the same time, the server may register as inactive the previously active mobile device of the activation pool.

### FIELD

Disclosed are methods and electronic devices for use in a mobile communication network, and more particularly methods and electronic devices for coordinating a single telephone number among multiple mobile communication devices of an activation pool of mobile communication devices.

### BACKGROUND

Mobile communication devices, such as cellular telephones, have become an important part of everyday life. Many subscribers own more than one mobile communication device. For example, different devices may have different device capabilities; a particular device may have still or video camera capability, or multimedia playback capability. As another example, a subscriber may own multiple mobile communication devices in order to have available a range of applications and accessories to coordinate with the user's appearance and life style.

An executive may wish, during the day, to coordinate her cellular telephone, PDA, or other mobile device with her business needs. For her daily use, she may own a “business phone,” with many business applications and a business-like, professional look. While entertaining or otherwise out for the evening, she may prefer to carry a small cellular phone better coordinated to her evening attire, having a dressier or more fashionable look, that is an “evening phone” which can easily fit into a small evening bag. On the weekend, or when out with friends, she may want to carry along a mobile communication device with a sportier look, that is a “fun phone,” that may include, for example an MP3 player and a video camera.

At present, an owner of two or more code division multiple access (CDMA) phones cannot easily switch between phones making one active and another inactive. For a user of a CDMA phone, the existing CDMA phone identity procedures are typically locked to a particular piece of hardware of a particular phone. To switch between phones, the solution of a removable user identity module (R-UIM), that is a small chip that can be manually removed from a phone and placed in another telephone, can be difficult for users to manually manipulate. Thus, a more convenient solution to the problem of switching between phones is desirable.

### BRIEF DESCRIPTION OF THE DRAWINGS

FIG. 1 shows an embodiment of a system including a communication network and an activation pool of mobile communication devices;

FIG. 2 shows an embodiment of a server that can operate in the network of FIG. 1;

FIG. 3 shows an embodiment of a mobile communication device that can operate in the network of FIG. 1;

FIG. 4 shows a signal diagram of an embodiment of a method of a communication network, for example a CDMA communication network; and

FIG. 5 shows a flow chart of an embodiment of a method of a server of a communication network that may be, for example, a CDMA communication network.

### DETAILED DESCRIPTION

It would be beneficial to have methods and devices by which an owner of multiple CDMA mobile communication devices can easily transfer an operational identity between two such devices, making one active and another inactive, but maintain the same telephone number or other operational identity. A set of commonly owned CDMA devices, described below as an activation pool, is configured to easily transfer an operational identity between the devices so that one CDMA phone may be actively associated with the operational identity at a given time. The operational identity may be, for example, a user account number, a telephone number, or other identifier that can identify the active CDMA device in the CDMA communication network. The operational identity allows telephone calls or other communications to be sent to one device of the set of commonly owned devices via, for example a service provider.

To activate an operational identity of a particular device of an activation pool, a CDMA device may transmit a signal to a server of the service provider to make active the CDMA device and to operate the CDMA device under the operational identity. The active CDMA device may be registered as active with the service provider, and the previously active CDMA device may be registered as inactive. In this manner the operational identity can be coordinated among the set of CDMA devices of the activation pool. Thus, a user may switch between commonly owned CDMA devices using the phone of her choice in the activation pool without the need to physically transfer an R-UIM or other device component between mobile communication devices.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims. It is understood that the use of relational terms, if any, such as first and second, up and down, and the like are used solely to distinguish one from another entity or action without necessarily requiring or implying any actual such relationship or order between such entities or actions.

At least some inventive functionality and inventive principles may be implemented with or in software programs or instructions and integrated circuits (ICs) such as application specific ICs. In the interest of brevity and minimization of any risk of obscuring the principles and concepts according to the present invention, discussion of such software and ICs, if any, is limited to the essentials with respect to the principles and concepts within the preferred embodiments.

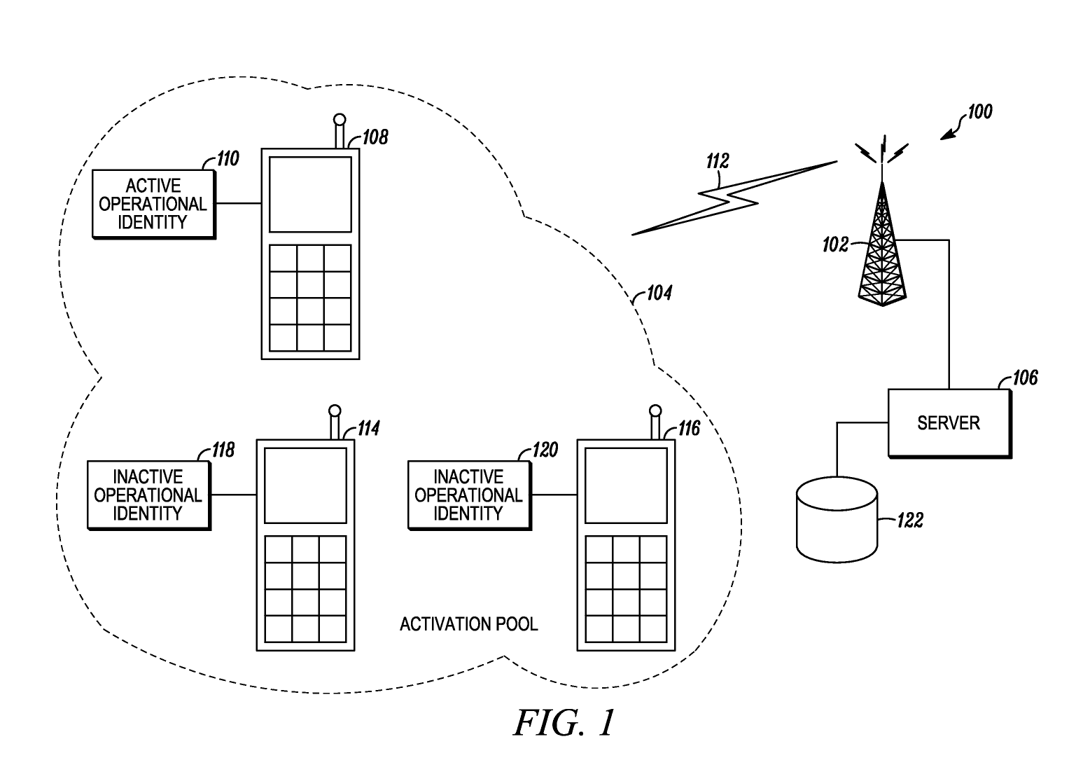

FIG. 1 shows an embodiment of a system 100 including a communication network 102 and an activation pool 104 of mobile communication devices. An activation pool 104 is a group of mobile communication devices tied together, for example by common ownership. A set of commonly owned mobile communication devices is described as an activation pool 104, in that one phone or mobile communication device may be actively associated with an operational identity at a given time. A user may choose to use one mobile communication device at one time and at a different time may choose to use a different mobile communication device that is within the activation pool 104.

Each mobile communication device within the activation pool 104 is configured to communicate in accordance with its operational identity. That is, if a mobile communication device in the activation pool 104 is active, its operational identity is active. If the mobile communication device in the activation pool is inactive, its operational identity is inactive. An operational identity may be, for example, a telephone number or other identifier that can identify the active mobile communication device 108 in the communication network 102. Telephone calls or other communications 112 may be sent via the network 102 to the one active device 108 of the set of commonly owned devices via, for example a service provider. The network 102 may communicate 112 with a mobile communication device 108 with an active operational identity 110. Other devices within the activation pool 104, in this example mobile communication device 114 and mobile communication device 116, may be configured with the same operational identity, which in this example is inactive 118 and 120, respectively. In this way a user can choose to use a mobile communication device of their preference within the activation pool 104.

The mobile communication device 108 of the activation pool 104 acquires an operational identity 110 via a server 106 that is configured to enable the operational identity. As just discussed, an operational identity may be, for example, a telephone number or other identifier that can identify an active mobile communication device 108 in the communication network 102. The operational identity may be associated in the server 106, or in a database of the server 106, with other data associated with the mobile communication device, for example, a billing account number or user account number. In an embodiment, the user account number may in addition serve as the operational identity.

At power up of the mobile communication device 108, in order to communicate 112 with another remote mobile communication device (not shown) having a different operational identity, the server 106 can activate the operational identity 110 of the mobile communication device 108. At the same time, other mobile communication devices 114, 116 of the activation pool 104 of mobile communication devices are registered by the server as inactive, and may have an inactive operational identity, for example, 118 and 120, respectively, or none at all.

The communication network 102 may be a code division multiple access (CDMA) communication network, or another Third Generation Partnership Project 2 (3GPP2) compliant communication network. Similarly, the mobile communication devices may be CDMA devices or other 3GPP2 compliant mobile communication devices. It is understood that other 3GPP2 compliant methods and devices are within the scope of this discussion.

A set of commonly owned mobile communication devices is described as an activation pool 104, in that one phone or mobile communication device 108, for example, may be actively associated with an operational identity 110, for example, at a given time. As mentioned above, the operational identity 110 may be, for example, a user account number, a telephone number, or other identifier that can identify the active mobile communication device 108 in the communication network 102 so that telephone calls or other communications 112 may be sent via the network 102 to the one active device 108 of the set of commonly owned devices via, for example a service provider.

As discussed above, the mobile communication devices of the activation pool 104, and the server 106 of the communication network 102, are configured so that a mobile communication device may be registered upon power up as active with the communication network 102, and the previously active mobile communication device may be registered as inactive. In this manner the operational identity can be coordinated among the set of mobile communication devices for example 108, 114, and 116 of the activation pool 104 so that a user may switch between mobile communication devices of the activation pool 104 in order to use the phone of her choice without the need to physically transfer an R-UIM or other device component between mobile communication devices. Thus, by the methods and devices described below an owner or user of multiple mobile communication devices of an activation pool can easily transfer an operational identity between two such devices, making one active and another inactive, but maintaining the same telephone number or other operational identity.

The mobile communication devices 108, 114, and 116, as discussed above, belong to an activation pool 104 and may be commonly owned. Each such device has an identifying number, for example an electronic serial number (ESN) or mobile equipment identifier (MEID), by which it may be identified to the server 106 of the communication network 102. By comparing the identifying number with a database, for example database 122, the server 106 can determine whether a mobile communication device has a transferable identity.

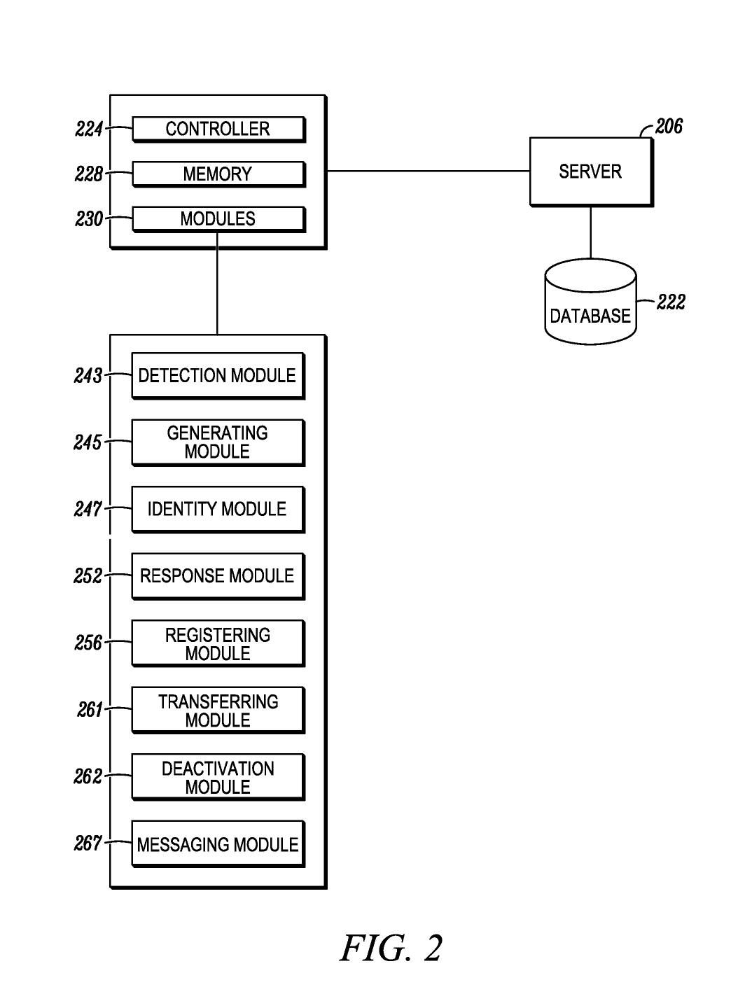

A mobile communication device has a transferable identity when the mobile communication device belongs to an activation pool 104 of mobile communication devices such as 108, 114, and 116, any one of which able to acquire an operational identity associated with the activation pool 104 in a manner that leaves the other members of the activation pool 104 without an active operational identity. That is, the operational identity may be transferred to the one mobile communication device. As just described, a database 122 accessible to the server may include identifying numbers of mobile communication devices along with operational identities associated with the mobile communication devices. When two or more mobile communication devices are associated in the database 122 with the same operational identity, those devices belong to the same activation pool 104. Thus, the server 106 may be able to determine whether a mobile communication device has a transferable identity. Further details of the server are described in connection with FIG. 2.

FIG. 2 shows an embodiment of a server 206 that can operate in the network of FIG. 1. The server 206 includes a controller 224 configured to execute instruction modules 230. The server also includes a memory 228 configured to store data and to store instruction modules. The modules 230 may include a detection module 243 configured to receive a signal indicating a powering up of a mobile communication device, and further include a generating module 245 configured to generate a message to a mobile communication device indicating that the mobile communication device is inactive, and a response module 252 configured to receive an activation choice signal from the mobile communication device to register the mobile communication device as an active mobile communication device.

The modules 230 may in addition include an identity module 247 configured to determine that the mobile communication device has a switchable identity, and also include a registering module 256 configured to register the mobile communication device as an active mobile communication device to the exclusion of others of a plurality of mobile communication devices of an activation pool of mobile communication devices. The modules 230 further include a transferring module 261 configured to transfer the operational identity to the mobile communication device, and a deactivation module 262 configured to register as inactive mobile communication devices, the other mobile communication devices of the activation pool. The modules 230 may also include a messaging module 267 configured to send for each of the other mobile communication devices of the activation pool, an SMS message, or any other type of message, to the other mobile communication device indicating that the other mobile communication device is inactive.

The modules can carry out certain processes of the methods as described herein. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The operations in accordance with the modules will be discussed in more detail below.

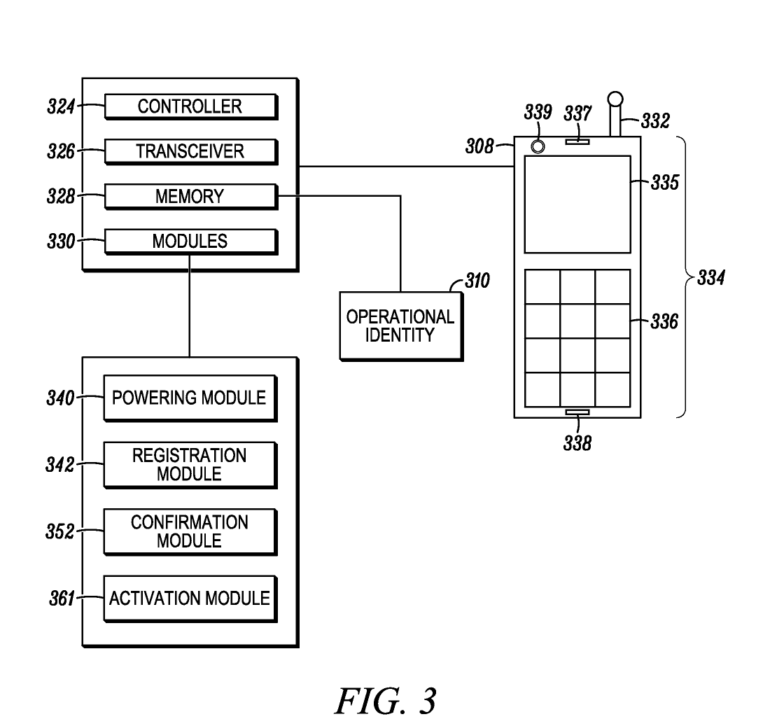

FIG. 3 shows an embodiment of a mobile communication device 308 that can operate in the network of FIG. 1. The mobile communication device 308 includes a controller 324 configured to execute instruction modules. The mobile communication device 308 in addition includes a transceiver 326 coupled to the controller, and a memory 328 configured to store data such as an operational identity 310 and instruction modules. It is understood that the description provided here of the mobile communication device 106 of FIG. 1 may also describe other mobile communication devices of the activation pool 104.

The mobile communication device 308 may be implemented as a cellular telephone (also called a mobile phone). The mobile communication device 308, for example, may include a cellular antenna 332 that may be coupled to the transceiver 326. The mobile communication device 308 also includes a user interface 334 coupled to the controller 324, and modules 330.

The mobile communication device 308 represents a wide variety of devices that have been developed for use within various networks. Such handheld communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP).

The user interface 334 may include a display 335 and a keypad 336. A speaker 337 and microphone 338 may be a user interface for a speech recognition application and for other voice applications. It is understood that any type of user interface is within the scope of this discussion. The user interface 334 is configured to receive activation choice input to operate the mobile communication device 308 under the operational identity to the exclusion of other mobile communication devices of the plurality of mobile communication devices of the activation pool 104 (see FIG. 1). In addition, the user interface 334 may allow a user access to the content of an application running on the device 308, for example a communication application such as an SMS messaging application.

The user interface 334 may also include a fingerprint sensor, camera, or other sensors that may be used to confirm the identity of a user. For example, the display 335 may include a touch sensitive portion that may be configured to effect a fingerprint scan. In another embodiment the mobile communication device 308 may include a separate fingerprint sensor. In yet another embodiment, the mobile communication device 308 may include a camera 339. While attempting to activate the device 308 a user may be required to enter a password, passcode, scan a fingerprint, and/or use facial recognition to validate his or her identity as an authorized user of the account. Thus, the user interface may be configured to receive identification and authentication input including at least one of a fingerprint scan, a facial image, a passcode, and a password. It is understood that identifying and authenticating the user may be carried out in any manner as known in the art.

The modules 330 may be configured with instructions to carry out steps of the described method. The modules 330 include a powering module 340, a registration module 342, a confirmation module 352, and an activation module 361. Steps of methods may involve modules and modules may be inferred by the methods discussed herein. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The operations in accordance with the modules will be discussed in more detail below.

The powering module 340 is configured to power up the mobile communication device. The power up may take place, for example, in response to a press of a key of the user interface 334 keypad 336. The power up may instead be in response to activation of the mobile communication device via for example an on-off switch of the device, or the result of a timer expiring in the controller 324. Upon power up the device may execute self-test functions as well as loading of data and of instructions for execution by the controller 324.

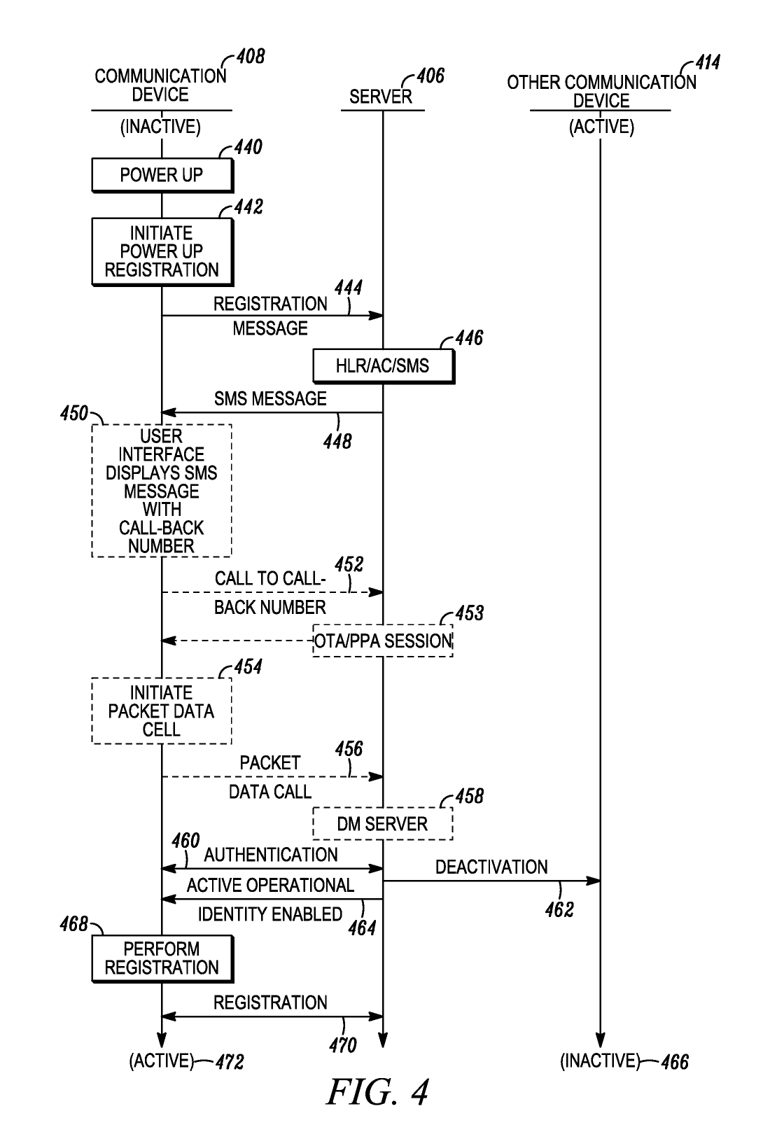

The registration module 342 is configured to generate a signal to the server 206 (see FIG. 2) to perform a power up registration of the mobile communication device 308. The signal may take the form of a registration message. The registration message may include a mobile communication device identifier, as discussed below. The registration message may in addition include other data related to authorization of the device to operate in the communication network 102 (see FIG. 1). Registration of the mobile communication device 308 is discussed in detail in connection with FIG. 4.

The confirmation module 352 is configured to send an activation choice signal in response to a message from a server of the communication network 102 (see FIG. 1) that the mobile communication device 308 is inactive. The activation choice signal may be, in an embodiment, in the form of an SMS message, for example, via entry by the user of a call-back number such as the key sequence *224 on the keypad 336. In an embodiment the activation choice signal may be in the form of packet data, for example, if the mobile communication device is capable of IP-based communication with a server. The call-back number and packet data call options are discussed below in connection with the signal diagram of FIG. 4.

The activation module 361 is configured to receive the operational identity for example 310 from the server 106 (see FIG. 1) for storage in the memory 328. As discussed above, the operational identity 310 enables operation of the mobile communication device 308 in the communication network 102. After receipt of the operational identity the mobile communication device 308 is known to the communication network 102 and can initiate and receive communications via the network 102 under the operational identity.

FIG. 4 shows a signal diagram of an embodiment of a method of a communication network, for example a CDMA communication network. The signal diagram illustrates the process that may take place according to the described methods and devices. The signal diagram involves, for illustration purposes, three devices, an initially inactive mobile communication device 408 belonging to an activation pool 104 (see FIG. 1), a server 406 of a communication network 102, and an initially active other mobile communication device 414 of the activation pool 104. The signal diagram in addition illustrates signals that may pass between the mobile communication devices 408 and 414, and the server 406.

As described previously, a user may power up 440 an initially inactive mobile communication device of the activation pool 104 (see FIG. 1). The power up may take place, for example, in response to a press of a key of keypad 336 (see FIG. 3) of the user interface 334. The power up may instead be in response to activation of the mobile communication device via for example an on-off switch of the device.

Upon power up, the mobile communication device may initiate a power up registration procedure 442. The power up registration procedure may occur according to a powering module 340 (see FIG. 3). The power up registration procedure may include a device self-test as well as loading of data and of instructions for execution by the controller 324. The power up registration procedure may include transmission of a registration message 444 to the server 406.

The registration message 444 typically includes a mobile communication device identifier, such as for example, an electronic serial number (ESN) or a mobile equipment identifier (MEID). An electronic serial number (ESN) is a unique identification number placed within the mobile communication device by the manufacturer. The ESN may be embedded or inscribed on a microchip in the device. The MEID is a unique number that identifies a physical piece of CDMA mobile station equipment throughout the world, and has been introduced to replace use of ESNs.

The registration message 444 may include other data related to authorization of the device to operate in the communication network 102 (see FIG. 1). For example, the registration message 444 may include a mobile identification number (MIN) and/or may include an international mobile subscriber identity (IMSI). The MIN is another mobile device identification number that conforms to particular standards. The IMSI identifies the subscriber to the network, and for example may be included in a SIM card for GSM phones or in an R-UIM card for CMDA devices.

When the registration message 444 is received by the server 406, it is processed by a Home Location Register (HLR) accessed by the server. The HLR is a central database that includes details of each subscriber of the communication network 102 (see FIG. 1). For example, the HLR includes the IMSI and may include other data stored in the SIM or R-UIM card. The server in addition includes an authentication center (AC) that may authenticate the SIM card or other authentication component embedded in the mobile communication device 408. The HLR and the AC function together with other components of the server 446 to attempt registration of the mobile communication device 408 in response to the registration message 444.

The server may generate a message to the mobile communication device 408 in accordance with the generating module 245 (see FIG. 2). The generating module 245 is configured to generate a message to a first mobile communication device, for example mobile communication device 408, of an activation pool 104 (see FIG. 1) of mobile communication devices. The activation pool 104 is configured to coordinate an operational identity, for example operational identity 110, among mobile communication devices 108, 114, and 116 of the activation pool 104. The message generated by the generating module 245 is to indicate to a user of the mobile communication device 408 that the mobile communication device 408 is inactive. The server 406 may execute instructions of the generating module 245 upon determining that the mobile communication device 408 has been powered up, in accordance with the detection module 243.

Other components of the server may provide, for example, SMS messaging functionality. Upon processing the registration message 444, the server may acknowledge the registration message and transmit 448 to the mobile communication device 408 an SMS message. Depending on the capability and/or configuration of the mobile communication device, the SMS message may include instructions to the mobile communication device according to different options.

The mobile communication device 408 is capable of receiving an SMS message 448. In a first option, the SMS message may include text to be displayed 450 to the user of the mobile communication device 408, via, for example, the display 335 (see FIG. 3) of the user interface 334. The text of the SMS message may for example ask the user if he or she wishes to activate the mobile communication device 408. The text may in addition include a call-back number, for example, *224, that the user would enter into the mobile communication device in order that the registration process continue 452. The server may continue 475 with the registration and authentication process by executing an Over-the-Air Provisioning and Parameter Administration (OTA/PPA) Session 453 with the mobile communication device 408.

The mobile communication device 408 may be capable in addition of initiating a packet data call. For example, the mobile communication device may connect to the communication network 102 (see FIG. 1) via WiFi or another technology that can utilize IP to send and receive wireless packet data to and from the mobile communication device. Thus in a second option, the SMS message may include instructions to the mobile communication device 408 to initiate 454 a packet data call to an IP-based over-the-air (IOTA) device management (DM) server address included in the SMS message, in order that the registration process continue 456. The device management server may support provisioning the mobile communication device 408 for authentication 460 and for successful operation in the communication network 102 (see FIG. 1). The server 406 may continue with the registration and authentication process via the DM session 458 with the mobile communication device 408. Interaction with the DM may be transparent to the user. In yet another embodiment, the server may detect an initiation of a communication by the mobile communication device 408, that is, for example, the user may continue entering keystrokes to make a phone call. The server may treat the initiation of the communication as a signal to operate the device 408 under the operational identity 110, and on such basis may continue with the registration and authentication process.

Authentication of the mobile communication device 408 may proceed 460 whether according to the first, call-back 452 option, or whether according to the second, IP-based 456 option, or in response to the user continuing to make a phone call. The server 406 provides authentication 460 to the mobile communication device and deactivates 462 the other hitherto active communication device of the activation pool 104 (see FIG. 1). The deactivation 462 may also be referred to as a deactivation message 462. The server 406 may further provide to the mobile communication device 408 an operational identity 110 and may enable that the operational identity be active 464.

The deactivation 462 of the other mobile communication device need not entail remotely powering down the other communication device 414. However, upon deactivation, the other communication device is no longer registered for operation within the communication network 102 (see FIG. 1). Moreover, upon deactivation 462 by the server 406, the other mobile communication device lacks an active operational identity, that is, its operational identity is inactive 466. If the communication device 414 is in active communication (for example, in a voice call, or in an active data session), receiving the deactivation message 462 may optionally have one of a plurality of results. In an embodiment the message 462 may cause the device 414 to terminate all non-emergency communication. In another embodiment, the message 462 may result in the device being permitted to finish the existing communication session, but further communication sessions may not be allowed. In still another embodiment, if the device 414 is in active communication at the time of the deactivation message 462, the activation of communication device 408 may be suspended until device 414 concludes the active communication session.

The mobile communication device 408, upon receiving an active operational identity may continue with additional processing 468 preparatory to acquiring full access to the communication network 102 (see FIG. 1). The mobile communication device may for example exchange further messages with the server 406, messages that may include an ESN or MEID, an IMSI, MIN, or other data of the mobile communication device 408. The mobile communication device may further acknowledge to the server its registration 470 by the server to operate in the communication network 102 under the operational identity 110. Upon completion of the registration process, the mobile communication device 408 is configured for operation in the communication network 102 under its active operational identity 472.

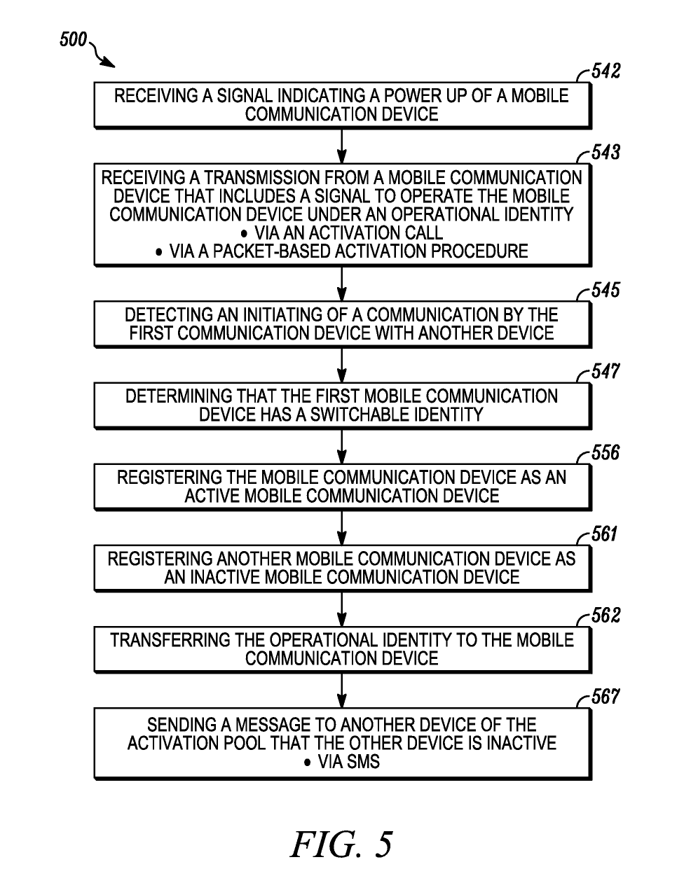

FIG. 5 shows a flow chart of an embodiment of a method 500 of a server 106 (see FIG. 1) of a communication network 102 that may be, for example, a CDMA communication network. When a user turns on his or her mobile communication device 108 for use, the server 106 receives a signal indicating a power up of the mobile communication device 542, in accordance with detection module 243 (see FIG. 2). As discussed above, the server 206 may include a detection module 243. The detection module 243 is configured to receive a signal indicating a powering up of an initially inactive mobile communication device, for example, mobile communication device 108. In this manner when a user powers up her mobile communication device 108, a signal may be sent to the communication network 102, and the server 206 may detect that the mobile communication device has been powered up.

In FIG. 5, the mobile communication device 108 (see FIG. 1) is initially inactive, and is a member of an activation pool 104 of mobile communication devices. As discussed above, an activation pool 104 of mobile communication devices includes a plurality of mobile communication devices that may be for example, commonly owned. The activation pool 104, as previously discussed, is configured to coordinate an operational identity among the plurality of mobile communication devices of the activation pool. As discussed above, the operational identity provides for operating a mobile communication device in the mobile communication system.

The server 106 (see FIG. 1) receives a transmission 543 from the mobile communication device 108 that includes a signal to operate the mobile communication device under the operational identity 110. The transmission from the mobile communication device 108 may be in response to an SMS message 448 (see FIG. 4) from the server 106 to the device. The SMS message may include for example a call-back number for a user to enter to indicate an activation choice 452. In another embodiment the SMS message may include an IP address of a Device Management (DM) server for an IP-based packet data transmission 456 from the mobile communication device 108, in order to indicate an activation choice. In the case involving a DM server, the packet data call may be transparent to the user.

In yet another embodiment, the server may detect 545 an initiation of a communication by the mobile communication device 108 (see FIG. 1). The server may treat the initiation of the communication as a signal to operate the device 108 under the operational identity 110.

The server 106 (see FIG. 1) receives the activation choice signal 452 or 456 (see FIG. 4), or even initiation of a phone call, in accordance with the response module 252 (see FIG. 2). The response module 252 is configured to receive an activation choice signal from the mobile communication device 108 to register the mobile communication device as an active mobile communication device. The activation choice signal is in addition a signal from the mobile communication device 108 to operate under the operational identity.

The server may determine 547 that the mobile communication device is one that has a switchable identity in accordance with identity module 247 (see FIG. 2). The identity module 247 is configured to determine that the mobile communication device 108 (see FIG. 1) has a switchable identity that enables membership of the mobile communication device 108 in the activation pool 104 of mobile communication devices. When the mobile communication device 108 has a switchable identity, the server 206 may configure the communication network 102 to enable operation of the mobile communication device 108 with the associated operational identity 110. The switchable identity enables membership of the mobile communication device 108 in the activation pool 104 of mobile communication devices, so that the server 206 may configure the communication network 102 (see FIG. 1) to enable operation of the mobile communication device 108 with the associated operational identity 110.

The server registers 556 the mobile communication device 108 (see FIG. 1) as an active mobile communication device according to instructions of registering module 256 (see FIG. 2). The mobile communication device 108 becomes registered in the communication network 102 as an active mobile communication device to the exclusion of others of the plurality of mobile communication devices of the activation pool.

The operation of the mobile communication device 108 (see FIG. 1) under the operational identity 110 occurs to the exclusion of others of the plurality of mobile communication devices of the activation pool 104, and is effected, as mentioned, through the registering module 256 (see FIG. 2) of the server 206. The registering module 256 is configured to register the mobile communication device 108 in the communication network 102 as an active mobile communication device to the exclusion of others of the plurality of mobile communication devices of the activation pool. In this manner no other mobile communication device of the activation pool 104 may operate within the communication network 102, without acquiring an active operational identity. It is understood that were another mobile communication device of the activation to acquire an active operational identity, a similar sequence of steps may take place in the server and in the appropriate mobile communication devices, in order that the other mobile communication device operate in the communication network to the exclusion of the remaining mobile communication devices of the activation pool, including the device 108.

The server 206 (see FIG. 2) transfers 561 the operational identity 110 (see FIG. 1) to the mobile communication device 108 in accordance with transferring module 261. The transferring module 261 is configured to transfer the operational identity for example operational identity 110 (see FIG. 1) to the mobile communication device 108. When transferred, the operational identity 110 may be stored in memory of the mobile communication device 108. The operational identity is also associated in the server 206 and/or database 222 of the server with the ESN, MEID, IMSI, and/or MIN of the mobile communication device 108. In this manner, the operational identity provides for operation of the mobile communication device 108 in the communication network 102 and within the activation pool 104.

The server 206 (see FIG. 2) registers as inactive 562 mobile communication devices, mobile communication devices of the activation pool other than the mobile communication device 108 (see FIG. 1) in accordance with deactivation module 262. The deactivation module 262 is configured to register as inactive mobile communication devices, mobile communication devices of the activation pool 104 (see FIG. 1) other than the mobile communication device 108. It is understood that the deactivation module 262 is a counterpart to the registering module 256, discussed above. Upon the server 206 executing instructions of the deactivation module 262, the server may further execute instructions of the messaging module 267.

In a step 567 the server sends a message to each of the other mobile communication devices of the activation pool 104 (see FIG. 1) indicating that the mobile communication device is inactive, in accordance with messaging module 267 (see FIG. 2). The messaging module 267 is configured to send an SMS message to each mobile communication device of the activation pool 104 other than the mobile communication device 106. The SMS message is to indicate that the other mobile communication device, for example, mobile communication device 114 and mobile communication device 116, is inactive.

The server 206 (see FIG. 2) may send, for example, an SMS message to each mobile communication device of the activation pool 104 (see FIG. 1) other than the mobile communication device 108 to indicate that the other mobile communication device, for example, mobile communication device 114 and mobile communication device 11 6, is inactive. In this manner the operational identity may be coordinated among the mobile communication devices of the activation pool 104.

The described methods and devices provide that an owner of multiple mobile communication devices of an activation pool can easily transfer an operational identity between two mobile communication devices of the activation pool, making one active and another inactive, but maintain the same telephone number or other operational identity. The operational identity may be, for example, a user account number, a telephone number, or other identifier that can identify the active mobile communication device in the communication network so that telephone calls or other communications may be sent to and/or received by one device of the set of devices of the activation pool. As described, a mobile communication device may transmit a signal to a server of the communication network to make active the mobile communication device and to operate the device under the operational identity. At the same time, the server may register as inactive the previously active mobile device of the activation pool. In this manner the operational identity can be coordinated among the set of mobile communication devices of the activation pool. Thus, a user may switch between mobile communication devices that belong to an activation pool using the device of her choice without the need to physically transfer an R-UIM or other device component between mobile communication devices.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. A method of a server of a mobile communication system and at least one initially inactive mobile communication device, the method comprising:
receiving a signal indicating a power up of an initially inactive mobile communication device as a first mobile communication device of a plurality of mobile communication devices comprising an activation pool, the activation pool configured to coordinate an operational identity among the plurality of mobile communication devices of the activation pool, the operational identity for operating in the mobile communication system; and
receiving a transmission from the first mobile communication device that includes a signal to operate the first mobile communication device under the operational identity.

2. The method of claim 1, further comprising
registering as an active mobile communication device, the first mobile communication device;
transferring the operational identity to the first mobile communication device; and
registering as inactive mobile communication devices, at least one of the mobile communication devices of the activation pool other than the first mobile communication device.

3. The method of claim 1, further comprising:
for each mobile communication device of the activation pool other than the first mobile communication device, sending a message to the mobile communication device indicating that the mobile communication device is inactive.

4. The method of claim 3, wherein:
for each mobile communication device of the activation pool other than the first mobile communication device, sending a message to the mobile communication device indicating that the mobile communication device is inactive,
comprises:
for each mobile communication device of the activation pool other than the first mobile communication device, sending an SMS message to the mobile communication device indicating that the mobile communication device is inactive.

5. The method of claim 1, wherein the signal transmitted is an activation choice signal, the method further comprising:
receiving a transmission from the first mobile communication device that includes an activation choice signal, via an activation call.

6. The method of claim 1, wherein receiving a transmission from the first mobile communication device that includes a signal which is an activation choice signal comprises:
receiving a transmission from the first mobile communication device that includes an activation choice signal, via a packet-based activation procedure.

7. The method of claim 1, further comprising:
determining that the first mobile communication device has a switchable identity that enables membership of the first mobile communication device in the activation pool of the plurality of mobile communication devices.

8. The method of claim 1, wherein receiving a transmission from the first mobile communication device that includes an activation choice signal comprises:
detecting an initiating by the first mobile communication device of a communication with another communication device.

9. A server of a communication network, the server comprising:
a controller configured to execute instruction modules;
a memory coupled to the controller and configured to store instruction modules;
a generating module configured to generate a message to a first mobile communication device of an activation pool of mobile communication devices, the activation pool configured to coordinate an operational identity among mobile communication devices of the activation pool, the message indicating that the first mobile communication device is inactive;
a response module configured to receive an activation choice signal from the first mobile communication device to register the first mobile communication device as an active mobile communication device and to operate under the operational identity to the exclusion of others of the plurality of mobile communication devices of the activation pool;
a registering module configured to register the first mobile communication device as an active mobile communication device to the exclusion of others of the plurality of mobile communication devices of the activation pool;
a transferring module configured to transfer the operational identity to the first mobile communication device; and
a deactivation module configured to register as inactive mobile communication devices, mobile communication devices of the activation pool other than the first mobile communication device.

10. The server of claim 9, further comprising:
a messaging module configured to send for each mobile communication device of the activation pool other than the first mobile communication device, an SMS message to the mobile communication device indicating that the mobile communication device is inactive.

11. The server of claim 9, further comprising:
a detection module configured to receive a signal indicating a powering up of an initially inactive mobile communication device.

12. The server of claim 9, further comprising:
an identity module configured to determine that the mobile communication device has a switchable identity that enables membership of the mobile communication device in the activation pool of mobile communication devices.

13. The server of claim 9, wherein the activation choice signal from the first mobile communication device comprises an activation choice signal transmitted by the first mobile communication device to the server via an activation call.

14. The server of claim 9, wherein the activation choice signal from the first mobile communication device comprises an activation choice signal transmitted by the first mobile communication device to the server via a packet-based activation procedure.

15. A mobile communication device of a system of mobile communication devices, the mobile communication device comprising:
a controller;
a transceiver coupled to the controller and configured to send and receive signals;
a memory coupled to the controller and configured to store instruction modules and data, the data including an operational identity, the operational identity defining a system of a plurality of mobile communication devices comprising an activation pool, the activation pool configured to coordinate the operational identity among the plurality of mobile communication devices of the activation pool, the operational identity for operating in a mobile communication network;
a user interface coupled to the controller configured to receive activation choice input to operate the mobile communication device under the operational identity to the exclusion of other mobile communication devices of the plurality of mobile communication devices of the activation pool;
a powering module configured to power up the mobile communication device;
a registration module configured to generate a signal to perform a power up registration of the mobile communication device;
a confirmation module configured to send an activation choice signal in response to a message from a server of the mobile communication network that the mobile communication device is inactive; and
an activation module configured to receive the operational identity from the server for storage in the memory;
wherein the transceiver is configured to transmit an activation choice signal and receive a confirmation of an activation choice to operate in the mobile communication network under the operational identity to the exclusion of other mobile communication devices of the plurality of mobile communication devices of the activation pool.

16. The mobile communication device of claim 15, wherein the confirmation module is further configured to send an activation choice signal via an activation call.

17. The mobile communication device of claim 15, wherein the confirmation module is further configured to send an activation choice signal via a packet-based activation procedure.

18. The mobile communication device of claim 15, wherein the mobile communication device is a code division multiple access (CDMA) device.

19. The mobile communication device of claim 15, wherein an activation choice signal comprises initiation of a phone call.

20. The mobile communication device of claim 15, wherein the user interface is further configured to receive identification and authentication input including at least one of a fingerprint scan, a facial image, a passcode, and a password.
